(19) United States
(12) Patent Application Publication
(10) Pub. No.: US 2008/0020207 A1
(43) Pub. Date: Jan. 24, 2008

(54) Particle With Rough Surface And Process For Producing The Same

(75) Inventors: Toshifumi Hashiba, Chiba (JP); Nami Tsukamoto, Chiba (JP); Kazutoshi Hayakawa, Chiba (JP); Satomi Kudo, Chiba (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Nisshinbo Industries, Inc., Tokyo (JP)

(21) Appl. No.: 11/569,458

(22) PCT Filed: May 24, 2005
(86) PCT No.: PCT/JP05/09457

§ 371 Date: Nov. 21, 2006

(30) Foreign Application Priority Data
May 24, 2004 (JP) 2004-152950

(51) Int. Cl. C08J 7/12; C08J 5/00

(52) U.S. Cl. 428/402; 525/540; 525/55

(57) ABSTRACT

A particle having a rough surface and obtained from a particle (A) having grafted on the surface thereof a polymer having first functional groups and particles (B) having grafted on the surface thereof a polymer having second functional groups reactive with the first functional groups, by uniting the particle (A) with the particles (B) through chemical bonds between the first functional groups and the second functional groups. In this particle with a rough surface, the core particle has been tenaciously bonded to the protruding particles. Because of this, even when the protruding particles have an increased particle diameter, the protruding particles can be prevented from readily shedding from the core particle.

### TECHNICAL FIELD

The present invention relates to a rough particle and a process for producing such a particle.

### BACKGROUND ART

New efforts have been devoted recently to the development of micron-size particles, and a degree of progress has been achieved also in the functionality of prepared composite particles.

Among composite particles, those in particular having asperities at the surface (referred to below as “rough particles”) enable the surface area of the particle itself to be increased. Hence, the use of rough particles in a broad range of applications, including plastic resin modifiers, functionalizing agents for coatings, organic pigments, electronic materials, toner particles, optical materials, separation materials, adhesives, pressure-sensitive adhesives, food products, cosmetics and biochemical carriers, is under investigation.

In general, such rough particles are almost always produced by using an electrical or physical technique to cause fine particles intended to serve as the protruding asperities to adhere to the surface of a core particle.

In cases where the core particles and/or the fine particles intended to serve as protrusions thereon are polymer particles, investigations have been carried out on producing rough particles by using, for example, collision forces, heat or a solvent to cause the solidified particles to unite by fusing together or embedment of the respective particles (Patent Document 1: Japanese Patent No. 2762507; Patent Document 2: Japanese Patent No. 3374593).

However, rough particles obtained by electrical adhesion using static charges or the like, or by physical adhesion involving collision forces or the like, have a serious drawback: the protrusions have a tendency to come off the core particle. Depending on the intended use of the particles, such a drawback may have undesirable consequences.

In the case of adhesion by embedment involving thermal fusion or adhesion through the use of mechanical and thermal energy applied by, for example, a hybridization system, the problem of protrusions coming off is resolved to some degree. Yet, such solutions are far from perfect, given that this problem may also be strongly affected by the glass transition points and softening temperatures of the core particle and the protrusions. Moreover, when such rough particles are administered various types of treatment such as plating treatment, there is a high likelihood that wide variations will arise in adhesion between particles, particle agglomeration and particle size, and that damage to the particles will occur.

One solution that has been proposed involves coating particles by chemically bonding together particles having reactive functional groups on their surfaces (Patent Document 3: JP-A 2001-342377).

The art in this Patent Document 3 is relatively useful when the particles used for coating are of a very small size.

However, if the particle size of the protruding particles on a rough particle is made larger to further increase the surface area of the rough particle, the surface area under load becomes larger, making the protrusions more likely to come off. Hence, stronger bonds are required between the component particles.

Patent Document 1: Japanese Patent No. 2762507

Patent Document 2: Japanese Patent No. 3374593

Patent Document 3: JP-A 2001-342377

### DISCLOSURE OF THE INVENTION

### Problems to be Solved by the Invention

It is therefore an object of the invention is to provide a rough particle in which the core particle and the protruding particles are strongly bonded, and thus prevent the protruding particles from readily coming off the core particle even when the protruding particles have been given a large particle size. A further object of the invention is to provide a process for producing such rough particles.

### Means for Solving the Problems

As a result of extensive investigations, the inventors have discovered that, in a rough particle made up of (A) a particle from a surface of which is grafted a polymeric compound containing a first functional group and (B) a particle from a surface of which is grafted a polymeric compound containing a second functional group capable of reacting with the first functional group, wherein the (A) particle and the (B) particle are united by chemical bonds between the first and second functional groups, the bond between the (A) particle and the (B) particle is strong, preventing the (B) particle from readily coming off.

Accordingly, the invention provides the following.
(1) A rough particle characterized by comprising (A) a particle from a surface of which is grafted a polymeric compound containing a first functional group and (B) a particle from a surface of which is grafted a polymeric compound containing a second functional group capable of reacting with the first functional group, wherein the (A) particle and the (B) particle are united by chemical bonds between the first and second functional groups.
(2) The rough particle of (1), characterized in that the chemical bonds are formed in a solvent that dissolves the polymeric compound containing the first functional group and the polymeric compound containing the second functional group.
(3) The rough particle of (1) or (2), characterized in that the (A) particle is a spherical or substantially spherical particle.
(4) The rough particle of any one of (1) to (3), characterized in that the (A) particle or the (B) particle or both is an organic polymer particle.
(5) The rough particle of any one of (1) to (4), characterized in that the first functional group and the second functional group are each of at least one type selected from among active hydrogen groups, carbodiimide groups, oxazoline groups and epoxy groups.
(6) The rough particle of (5), characterized in that the first functional group or the second functional group or both is a carbodiimide group.
(7) The rough particle of any one of (1) to (4), characterized in that the combination of the first functional group with the second functional group is a combination of at least one group selected from among hydroxyl groups, carboxyl groups, amino groups and mercapto groups with a carbodiimide group.
(8) The rough particle of any one of (1) to (7), characterized in that the (A) particle has an average particle size of from 0.1 to 1,000 μm. (9) A method of producing rough particles, characterized by mixing together (A) a particle from a surface of which is grafted a polymeric compound containing a first functional group and (B) a particle from a surface of which is grafted a polymeric compound containing a second functional group capable of reacting with the first functional group, in the presence of at least one type of solvent that dissolves the respective polymeric compounds on the surfaces of the (A) and (B) particles, and causing the first functional group to react with the second functional group.
(10) The method of producing rough particles of (9), characterized in that at least 0.01 g of the respective polymeric compounds dissolves in 100 g of the solvent.

### Effects of the Invention

In the rough particle of the invention, the bond between the (A) particle and the (B) particle is strong and the (B) particle does not readily come off, enabling the mechanical strength of protrusions on the rough particle to be maintained.

Therefore, the particle size of the (B) particles serving as the protrusions can be made larger and the specific surface area particular to the rough particles increased, in this way making it possible to provide functional particles having outstanding effects, including bonding ability, adhesion, tackiness, and dispersibility.

The rough particle of the invention having protrusions with such a good bond strength is well-suited to use in a broad range of applications, including applications in the electronics industry, such as electrostatic developers, LCD spacers, surface modifiers for silver halide film, film modifiers for magnetic tape, travel stabilizers for heat-sensitive paper, and toners; chemical sector applications, such as inks, adhesives, pressure-sensitive adhesives, light diffusing agents, paints, and paper coating agents for paper coatings and data recording forms; general industrial applications, such as fragrances, shrinkage-reducing agents, paper, dental materials and resin modifiers; cosmetics applications, such as slip agents and extender pigments that are added to liquid or powder-type cosmetics; health care applications, such as particles for antigen-antibody reaction tests; pharmaceutical and agricultural chemical applications; construction-related applications; and automotive applications.

### BRIEF DESCRIPTION OF THE DIAGRAMS

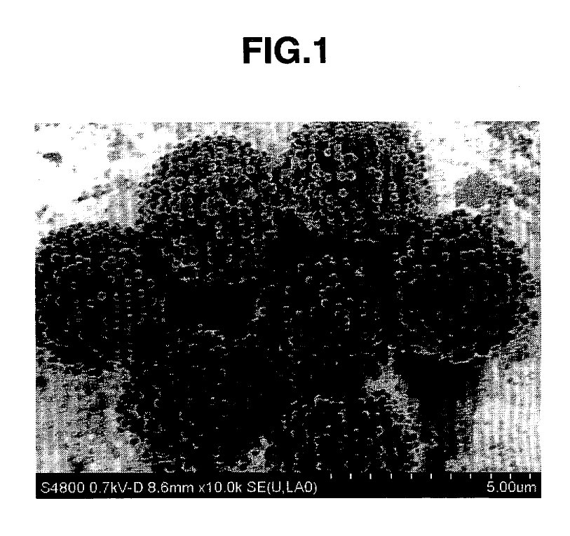

FIG. 1 is scanning electron micrograph of a rough particle obtained in Example 1. In FIG. 1, each line on the scale represents 0.5 μm.

### BEST MODE FOR CARRYING OUT THE INVENTION

The invention is described more fully below.

The rough particle of the invention is characterized by comprising (A) a particle from a surface of which is grafted a polymeric compound containing a first functional group (referred to below as the “first functional group-containing polymeric compound”) and (B) a particle from a surface of which is grafted a polymeric compound containing a second functional group capable of reacting with the first functional group (referred to below as the “second functional group-containing polymeric compound”), wherein the (A) particle and the (B) particle are united by chemical bonds between the first and second functional groups.

As used herein, “particle” is a concept which encompasses forms dispersed in a solvent, such as an emulsion. The particles may be cured particles or particles in a semi-cured state.

In the rough particle of the invention, a “protrusion” refers to a portion of the rough particle that originates from a (B) particle. This protrusion may be formed with a single (B) particle (primary particle) or may be formed by the agglomeration of a plurality of (B) particles. However, to increase the strength of the protrusions, it is preferable for an average of at least three non-agglomerated, monodispersed primary (B) particles to be bonded to the surface of the (A) particle.

The number of protrusions formed in this way from (B) particles is not subject to any particular limitation, so long as at least about three are present on the surface of the (A) particle. However, because the preferred number will vary depending on the surface area of the (A) particle, the average particle size of the (B) particles and other factors, it is desirable to select a suitable number based on such considerations as the intended use of the rough particles and the intervals between the protrusions.

The intervals between the protrusions may be set as desired so as to be either uniform or random. This interval may be changed by varying such conditions as the particle diameters of the (A) particles and (B) particles, the types of functional groups, the contents of the functional groups, the proportions in which the (A) particles and (B) particles are used, and the reaction temperature.

The (A) particles and (B) particles are not subject to any particular limitation with regard to shape, and may be given any desired particle shape. However, given the desire recently for higher precision rough particles, it is preferable that at least the (A) particles be spherical or substantially spherical particles.

The chemical bonds are not subject to any particular limitation, provided they are chemical bonds such as covalent bonds, coordinate bonds, ionic bonds or metallic bonds. However, to make the bonds between the (A) particles and the (B) particles more secure, it is preferable for the chemical bonds to be covalent bonds.

Any suitable technique may be used to form the above chemical bonds, although it is especially preferable for the bonds to be formed in a solvent which dissolves both the first functional group-containing polymeric compound and the second functional group-containing polymeric compound.

By thus reacting the first and second functional groups in a solvent which dissolves the respective polymeric compounds, the functional groups on the polymeric compounds can be used to the fullest possible extent compared with the reaction of the respective functional groups while the polymeric compounds in an undissolved state, thus increasing the number of reaction sites. As a result, the surface area of bonding increases, enabling the bonds between the (A) particles and the (B) particles to be made more secure.

No particular limitation is imposed on the materials making up the (A) particles and the (B) particles. Both may be made of either an organic material or an inorganic material (including a metallic material). However, for some applications, it is desirable that the particles not have a high specific gravity, in addition to which resilience may be required. Hence, it is advantageous for the (A) particles or the (B) particles or both to be made of an organic material. Organic polymer particles are preferred, and it is best for the (A) particles to be organic polymer particles.

The (A) particles and the (B) particles here may both have a single-layer structure, or they may have a multilayer structure in which the surfaces of the (A) particles and the (B) particles are covered with a coating ingredient.

The organic material is exemplified by crosslinked and non-crosslinked resin particles, organic pigments and waxes.

Illustrative examples of the crosslinked and non-crosslinked resin particles include styrene resin particles, acrylic resin particles, methacrylic resin particles, polyethylene resin particles, polypropylene resin particles, silicone resin particles, polyester resin particles, polyurethane resin particles, polyamide resin particles, epoxy resin particles, polyvinyl butyral resin particles, rosin particles, terpene resin particles, phenolic resin particles, melamine resin particles and guanamine resin particles.

Illustrative examples of organic pigments include azo pigments, polycondensed azo pigments, metal complex azo pigments, benzimidazolone pigments, phthalocyanine pigments (blue, green), thioindigo pigments, anthraquinone pigments, flavanthrone pigments, indanthrene pigments, anthrapyridine pigments, pyranthrone pigments, isoindolinone pigments, perylene pigments, perinone pigments and quinacridone pigments.

Illustrative examples of waxes include natural waxes of vegetable origin, such as candelilla wax, carnauba wax and rice wax; natural waxes of animal original, such as beeswax and lanolin; natural waxes of mineral origin, such as montan wax and ozokerite; natural, petroleum-based waxes such as paraffin wax, microcrystalline wax and petrolatum; synthetic hydrocarbon waxes such as polyethylene wax and Fischer-Tropsch wax; modified waxes such as montan wax derivatives and paraffin wax derivatives; hydrogenated waxes such as hardened castor oil derivatives; and synthetic waxes.

Of the various above organic materials, based on such considerations as the availability of particles having a uniform particle size, the ease of conferring functional groups and the monodispersibility of the particles, it is especially preferable to use crosslinked and non-crosslinked resin particles. Specifically, the use of vinyl resin particles such as styrene resin particles, acrylic resin particles or methacrylic resin particles is preferred.

These types of resin particles may be used singly or as combinations of two or more thereof.

If the particles that form the cores of the (A) particles and the (B) particles are particles made of polymeric compounds, the average molecular weight of each polymeric compound, while not subject to any particular limitation, will generally be from about 1,000 to about 3,000,000. The weight-average molecular weight is a measured value obtained by gel permeation chromatography.

Illustrative examples of inorganic materials include any of the following in the form of a powder or fine particles: alumina, titanium oxide, barium titanate, magnesium titanate, calcium titanate, strontium titanate, zinc oxide, silica sand, clay, mica, wollastonite, diatomaceous earth, chromium oxide, cerium oxide, iron oxide, antimony trioxide, magnesium oxide, zirconium oxide, aluminum oxide, magnesium hydroxide, aluminum hydroxide, barium sulfate, barium carbonate, calcium carbonate, silica, silicon carbide, silicon nitride, boron carbide, tungsten carbide, titanium carbide and carbon black; metals such as gold, platinum, palladium, silver, ruthenium, rhodium, osmium, iridium, iron, nickel, cobalt, copper, zinc, lead, aluminum, titanium, vanadium, chromium, manganese, zirconium, molybdenum, indium, antimony and tungsten, as well as alloys, metal oxides and hydrated metal oxides thereof; and inorganic pigments, carbon, and ceramics. These may be used singly or as combinations of two or more thereof.

The above organic materials and inorganic materials, if available as commercial products, may be used directly in the commercially available form, or such commercial products may be used following modification with a surface treatment agent such as a coupling agent.

Illustrative, non-limiting, examples of the surface treatment agent include unsaturated fatty acids, such as oleic acid; the metal salts of unsaturated fatty acids, such as sodium oleate, calcium oleate and potassium oleate; fatty acid esters; fatty acid ethers; surfactants; silane coupling agents, including such alkoxysilanes as methacryloxymethyltrimethoxysilane, methacryloxypropyltrimethoxysilane, n-octadecylmethyldiethoxysilane, dodecyltrimethoxysilane, 2-(3,4-epoxycyclohexyl)ethyltrimethoxysilane, 2-(4-chlorosulfonyl)ethyltrimethoxysilane, triethoxysilane, vinyltrimethoxysilane and phenethyltrimethoxysilane; titanate coupling agents; and aluminum coupling agents.

Preferred combinations of the (A) particles and the (B) particles are exemplified as follows.

(1) Particle (A)

Styrene resin particles, acrylic resin particles, methacrylic resin particles, etc.

(2) Particle (B)

Alumina, silica, titanium oxide, zinc oxide, magnesium hydroxide, aluminum hydroxide, etc.

The respective functional groups present in the first functional group-containing polymeric compound and the second functional group-containing organic compound are not subject to any particular limitation, and can be selected in any desired combination that enables chemical bonding to occur between both functional groups.

Specific examples of the functional groups include vinyl, aziridine, oxazoline, epoxy, thioepoxy, amide, isocyanate, carbodiimide, acetoacetyl, carboxyl, carbonyl, hydroxyl, amino, aldehyde, mercapto and sulfonic acid groups.

It is preferable for the first functional group or the second functional group or both to be at least one type of functional group selected from among the following which have a high reactivity and are capable of easily forming strong bonds: active hydrogen groups (e.g., amino, hydroxyl, carboxyl, mercapto), carbodiimide groups, epoxy groups and oxazodline groups. A carbodiimide group is especially preferred.

Preferred used can be made of active hydrogen groups (e.g., amino, hydroxyl, carboxyl, mercapto) because many organic compounds contain such groups, and a plurality of functional groups can easily be added by radical polymerization or the like. The above first and second functional groups can each be used singly or as combinations of two or more thereof.

The combination of the first and second functional groups is more preferably a combination of at least one type of group selected from among hydroxyl, carboxyl, amino and mercapto groups with a carbodiimide group. In this way, the bond strength between the (A) particles and the (B) particles can be further increased.

The first functional group-containing polymeric compound, the second functional group-containing polymeric compound, and compounds which may serve as these respective polymeric compounds are exemplified by the following compounds.

(1) Vinyl Group-Bearing Compounds

Examples of vinyl group-bearing compounds which may serve as the polymeric compounds include (co)polymers of (i) styrene compounds such as styrene, o-methylstyrene, m-methylstyrene, p-methylstyrene, α-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene, and 3,4-dichlorostyrene; (ii) (meth)acrylate esters such as methyl acrylate, ethyl acrylate, n-butyl acrylate, isobutyl acrylate, propyl acrylate, hexyl acrylate, 2-ethylhexyl acrylate, n-octyl acrylate, dodecyl acrylate, lauryl acrylate, stearyl acrylate, 2-chloroethyl acrylate, phenyl acrylate, methyl α-chloroacrylate, methyl methacrylate, ethyl methacrylate, n-butyl methacrylate, isobutyl methacrylate, propyl methacrylate, hexyl methacrylate, 2-ethylhexyl methacrylate, n-octyl methacrylate, dodecyl methacrylate, lauryl methacrylate and stearyl methacrylate; (iii) vinyl esters such as vinyl acetate, vinyl propionate, vinyl benzoate and vinyl butyrate; (iv) (meth)acrylic acid derivatives such as acrylonitrile and methacrylonitrile; (v) vinyl ethers such as vinyl methyl ether, vinyl ethyl ether and vinyl isobutyl ether; (vi) vinyl ketones such as vinyl methyl ketone, vinyl hexyl ketone and methyl isopropenyl ketone; (vii) N-vinyl compounds such as N-vinylpyrrole, N-vinylcarbazole, N-vinylindole and N-vinylpyrrolidone; and (viii) vinyl fluoride, vinylidene fluoride, tetrafluoroethylene, hexafluoropropylene, fluoroalkyl group-bearing (meth)acrylate esters such as trifluoroethyl acrylate and tetrafluoropropyl acrylate, and polyfunctional vinyl group-bearing compounds such as divinylbenzene, divinylnaphthalene, ethylene glycol diacrylate, ethylene glycol dimethacrylate, triethylene glycol dimethacrylate, tetraethylene glycol dimethacrylate, 1,3-butylene glycol dimethacrylate, trimethylolpropane triacrylate, trimethylolpropane trimethacrylate, 1,4-butanediol diacrylate, neopentyl glycol diacrylate, 1,6-hexanediol diacrylate, pentaerythritol triacrylate, pentaerythritol tetraacrylate, pentaerythritol dimethacrylate, pentaerythritol tetramethacrylate, glycerol acryloxydimethacrylate, N,N-divinylaniline, divinyl ether, divinyl sulfide and divinyl sulfone. These may be used singly or as combinations of two or more thereof.

(2) Aziridine Group-Bearing Compounds

Examples of aziridine group-bearing compounds include (co)polymers of acryloylaziridine, methacryloylaziridine, 2-aziridinyl ethyl acrylate and 2-aziridinyl ethyl methacrylate. These may be used singly or as combinations of two or more thereof.

(3) Oxazoline Group-Bearing Compounds

Oxazoline group-bearing compounds that may be used in the invention are not subject to any particular limitation, although preferred compounds include those having at least three oxazoline rings.

Specific examples include (co)polymers obtained from unsaturated double bond-containing monomers having an oxazoline group, such as 2-vinyl-2-oxazoline, 2-vinyl-4-methyl-2-oxazoline and 2-vinyl-5-methyl-2-oxazoline.

Use can be made of commercial oxazoline group-bearing polymeric compounds, examples of which include the following Epocros series products: WS-500, WS-700, K-1010E, K-2010E, K-1020E, K-2020E, K-1030E, K-2030E and RPS-1005 (all products of Nippon Shokubai Co., Ltd.).

Given the frequent use lately of water or water-soluble solvents in order to reduce the impact on the environment, it is preferable to use a water-soluble or hydrophilic compound as the oxazoline group-bearing polymeric compound. Specific examples include such water-soluble oxazoline group-bearing compounds as WS-500 and WS-700 within the above Epocros series.

(4) Epoxy Group-Bearing Compounds

Epoxy group-bearing compounds that may be used in the invention are not subject to any particular limitation, although a compound having two or more epoxy groups is preferred.

Specific examples include (co)polymers obtained by addition polymerization from an unsaturated double bond-containing monomer, such as glycidyl (meth)acrylate, (β-methyl)glycidyl (meth)acrylate, 3,4-epoxycyclohexyl (meth)acrylate, allyl glycidyl ether, 3,4-epoxyvinylcyclohexane, di(β-methyl)glycidyl malate and di(β-methyl)glycidyl fumarate; glycidyl ethers of aliphatic polyols, such as ethylene glycol diglycidyl ether, propylene glycol diglycidyl ether, hexamethylene glycol diglycidyl ether, cyclohexanediol diglycidyl ether, glycerol triglycidyl ether, trimethylolpropane triglycidyl ether and pentaerythritol tetraglycidyl ether; glycidyl ethers of polyalkylene glycols, such as polyethylene glycol diglycidyl ether, polypropylene glycol diglycidyl ether and polytetramethylene glycol diglycidyl ether; polyester resin-based polyglycidyl compounds; polyamide resin-based polyglycidyl compounds; bisphenol A-based epoxy resins; phenolic novolak-based epoxy resins; and epoxyurethane resins. These may be used alone or any two or more may be used together. These may be used singly or as combinations of two or more thereof.

Use can be made of commercial epoxy group-bearing compounds, examples of which include the following Denacol series products: Denacol EX-611, -612, -614, -614B, -622, -512, -521, -411, -421, -313, -314, -321, -201, -211, -212, -252, -810, -811, -850, -851, -821, -830, -832, -841, -861, -911, -941, -920, -931, -721, -111, -212L, -214L, -216L, -321L, -850L, -1310, -1410, -1610 and -610U (all products of Nagase ChemteX Corporation).

Here too, given the frequent use lately of water or is water-soluble solvents in order to reduce the impact on the environment, it is preferable to use a water-soluble or hydrophilic compound as the epoxy group-bearing compound. Of the above epoxy group-bearing compounds, specific examples include the following water-soluble epoxy group-bearing compounds: (poly)alkylene glycol diglycidyl ethers such as (poly)ethylene glycol diglycidyl ether and (poly)propylene glycol diglycidyl ether; (poly)glycerol polyglycidyl ethers such as glycerol polyglycidyl ether and diglycerol polyglycidyl ether; and water-soluble epoxy group-bearing compounds such as sorbitol polyglycidyl ethers.

(5) Amide Group-Bearing Compounds

Examples of amide group-bearing compounds include (co)polymers of (meth)acrylamide, α-ethyl (meth)acrylamide, N-methyl (meth)acrylamide, N-butoxymethyl (meth)acrylamide, diacetone (meth)acrylamide, N,N-dimethyl (meth)acrylamide, N,N-diethyl (meth)acrylamide, N,N-dimethyl-p-styrenesulfonamide, N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N-[2-(meth)acryloyloxyethyl]piperidine, N-[2-(meth)acryloyloxyethylene]pyrrolidine, N-[2-(meth)acryloyloxyethyl]morpholine, 4-N,N-dimethylamino)styrene, 4-(N,N-diethylamino)styrene, 4-vinylpyridine, 2-dimethylaminoethyl vinyl ether, 2-diethylaminoethyl vinyl ether, 4-dimethylaminobutyl vinyl ether, 4-diethylaminobutyl vinyl ether and 6-dimethylaminohexyl vinyl ether. These may be used singly or as combinations of two or more thereof.

(6) Isocyanate Group-Bearing Compounds

Isocyanate group-bearing compounds that may be used in the invention include 4,4′-dicyclohoexylmethane diisocyanate, m-tetramethylxylylene diisocyanate, 2,4-tolylene diisocyanate, 2,6-tolylene diisocyanate, mixtures of 2,4-tolylene diisocyanate and 2,6-tolylene diisocyanate, crude tolylene diisocyanate, crude methylene diphenyl diisocyanate, 4,4′,4,4″-triphenylmethylene triisocyanate, xylylene diisocyanate, hexamethylene-1,6-diisocyanate, tolidine diisocyanate, hydrogenated methylenediphenyl diisocyanate, m-phenyl diisocyanate, naphthalene-1,5-diisocyanate, 4,4′-biphenylene diisocyanate, 4,4′-diphenylmethane diisocyanate, 3,3′-dimethoxy-4,4′-biphenyl diisocyanate, 3,3′-dimethyldiphenylmethane-4,4-diisocyanate and isophorone diisocyanate; polymers having terminal isocyanate groups that are obtained by the polymerization (e.g., urea modification, urethane modification) of the foregoing isocyanates; and compounds obtained by polymerizing isocyanate group-bearing vinyl monomers such as isocyanate ethyl (meth)acrylate, isocyanate propyl (meth)acrylate and meta-isopropenyl-α,α-dimethylbenzyl isocyanate. These may be used singly or as combinations of two or more thereof.

(7) Carbodiimide Group-Bearing Polymeric Compounds

Carbodiimide group-bearing polymeric compounds that may be used in the present invention are not subject to any particular limitation. Examples include compounds of the following formula.
A^{x}-(R¹—X)ₙ—R²-A^{y} (I)
In the formula, A^{x} and A^{y} are each independently like or unlike segments, R¹ and R² are each independently organic groups having a valence of two or more, X is a carbodiimide group, and the letter n is an integer of 2 or more.

Examples of the organic group having a valence of two or more include hydrocarbon groups, and organic groups which include a nitrogen or oxygen atom. A divalent hydrocarbon group is preferred. Examples of divalent hydrocarbon groups include C₁ to C₁₆ alkylene groups which may be linear, branched or cyclic, C₆ to C₁₆ aryl groups, and C₇ to C₁₈ aralkyl groups.

Carbodiimide compounds of above formula (I) can be prepared in the presence of a catalyst which promotes conversion of the isocyanate group on an organic polyisocyanate compound to a carbodiimide group.

For example, such preparation can be carried out by the method disclosed in JP-A 51-61599, the method of L. M. Alberino et al. (J. Appl. Polym. Sci., 21, 190 (1990)), or the method disclosed in JP-A 2-292316.

Organic polyisocyanate compounds which may serve as the starting material are exemplified by the same compounds as the isocyanate group-bearing polymeric compounds mentioned in (7) above.

The carbodiimide-forming reaction is carried out by heating the isocyanate compound in the presence of a carbodiimidation catalyst. At this time, the molecular weight (degree of polymerization) can be adjusted by adding at an appropriate stage, as an end-capping agent, a compound having a functional group capable of reacting with the isocyanate group and thereby capping (converting to segments) the ends of the carbodiimide compound. The degree of polymerization can also be adjusted by means of such parameters as the concentration of, for example, the polyisocyanate compounds and the reaction time. Depending on the intended application, it is also possible to carry out the reaction without capping the ends; that is, with the isocyanate groups left unmodified.

The end-capping agent is exemplified by compounds having a hydroxyl group, a primary or secondary amino group, a carboxyl group, a thiol group or an isocyanate group. By capping (converting to segments) the ends of the carbodiimide compound, the molecular weight (degree of polymerization) can be adjusted.

Here too, given the frequent use lately of water or water-soluble solvents in order to reduce the impact on the environment, it is preferable to use a compound having water-soluble or hydrophilic segments as the carbodiimide compound.

The water-soluble or hydrophilic segments (A^{x} and A^{y}) in the above formula are not subject to any particular limitation, provided they are segments capable of making the carbodiimide compound water-soluble. Specific examples include alkylsulfonate residues having at least one reactive hydroxyl group, such as sodium hydroxyethanesulfonate and sodium hydroxypropanesulfonate; quaternary salts of dialkylaminoalcohol residues such as 2-dimethylaminoethanol, 2-diethylaminoethanol, 3-dimethylamino-1-propanol, 3-diethylamino-1-propanol, 3-diethylamino-2-propanol, 5-diethylamino-2-propanol and 2-(di-n-butylamino)ethanol; quaternary salts of dialkylaminoalkylamine residues such as 3-dimethylamino-n-propylamine, 3-diethylamino-n-propylamine and 2(diethylamino)ethylamine; and poly(alkylene oxide) residues having at least one reactive hydroxyl group, such as poly)ethylene oxide) monoethyl ether, poly)ethylene oxide) monoethyl ether, poly)ethylene oxide-propylene oxide) monomethyl ether and poly(ethylene oxide-propylene oxide) monoethyl ether. These segments (A^{x}, A^{y}) that become hydrophilic may be of one type alone or may be used in a combination of two or more types. Use as a copolymerized mixed compound is also possible.

(8) Acetoacetyl Group-Bearing Compounds

Examples of acetoacetyl group-bearing compounds include (copolymers of allyl acetoacetate, vinyl acetoacetate, 2-(acetoacetoxy)ethyl acrylate, 2-(acetoacetoxy)ethyl methacrylate, 2-(acetoacetoxyl)propyl acrylate and 2-(acetoacetoxy)propyl methacrylate. These may be used singly or as combinations of two or more thereof.

(9) Carboxyl Group-Bearing Compounds

The carboxyl group-bearing compounds are not subject to any particular limitation. Examples include (co)polymers of various unsaturated mono- or dicarboxylic acid compounds or unsaturated dibasic acid compounds, such as acrylic acid, methacrylic acid, crotonic aid, itaconic acid, maleic acid, fumaric acid, monobutyl itaconate and monobutyl maleate. These may be used singly or as combinations of two or more thereof.

(10) Carbonyl Group-Bearing Compounds

Carbonyl group-bearing compounds include ketones such as acetone, methyl ethyl ketone and acetophenone, and esters such as ethyl acetate, butyl acetate, methyl propionate, ethyl acrylate and butyrolactone. These may be used singly or as combinations of two or more thereof.

(11) Hydroxyl Group-Bearing Compounds

Examples of hydroxyl group-bearing compounds include compounds obtained by (co)polymerizing hydroxyl group-bearing (meth)acrylic monomers such as 2-hydroxyethyl (meth)acrylate, 2-hydroxypropyl (meth)acrylate, 3-hydroxypropyl (meth)acrylate or 4-hydroxybutyl (meth)acrylate; polyalkylene glycol (meth)acrylic compounds such as polyethylene glycol mono(meth)acrylate and polypropylene glycol mono(meth)acrylate, and compounds obtained by the (copolymerization thereof; and hydroxyalkyl vinyl ether compounds such as hydroxyethyl vinyl ether and hydroxybutyl vinyl ether, hydroxyl group-bearing allyl compounds such as allyl alcohol and 2-hydroxyethyl allyl ether, and compounds obtained by the (co)polymerization thereof. These may be used singly or as combinations of two or more thereof.

In addition, hydroxyl group-bearing polymers such as fully or partially saponified resins of polyvinyl alcohols (PVA), and saponified resins of acetic acid ester-containing polymers composed of a copolymer of vinyl acetate with another vinyl monomer may also be used as hydroxyl group-bearing compounds.

(12) Amino Group-Bearing Compounds

Examples of amino group-bearing compounds include compounds obtained by (co)polymerizing the amino group-bearing alkyl ester derivatives of acrylic acid or methacrylic acid, such as aminoethyl acrylate, N-propylaminoethyl acrylate, N-ethylaminopropyl methacrylate, N-phenylaminoethyl methacrylate, and N-cyclohexylaminoethyl methacrylate; and compounds obtained by (co)polymerizing allylamine derivatives such as allylamine and N-methylallylamine, amino group-bearing styrene derivatives such as p-aminostyrene, or triazine derivatives such as 2-vinyl-4,6-diamino-S-triazine. Of these, compounds having a primary or secondary amino group are preferred. The foregoing compounds may be used singly or as combinations of two or more thereof.

(13) Aldehyde Group-Bearing Compounds

Examples of aldehyde group-bearing compounds include polymers of (meth)acrolein.

(14) Mercapto Group-Bearing Compounds

Examples of mercapto group-bearing compounds include (co)polymers of 2-mercaptoethyl (meth)acrylate, 2-mercapto-1-carboxyethyl (meth)acrylate, N-(2-mercaptoethyl)acrylamide, N-(2-mercapto-1-carboxyethyl)acrylamide, N-(2-mercaptoethyl)methacrylamide, N-(4-mercaptophenyl)acrylamide, N-(7-mercaptonaphthyl)acrylamide and maleic acid mono(2-mercaptoethylamide); and mercapto group-containing polymeric compounds such as mercapto group-containing modified polyvinyl alcohols. These may be used singly or as combinations of two or more thereof.

(15) Sulfonic Acid Group-Bearing Compounds

Examples of sulfonic acid group-bearing compounds include (co)polymers of alkenesulfonic acids such as ethylenesulfonic acid, vinylsulfonic acid and (meth)allylsulfonic acid; aromatic sulfonic acids such as styrenesulfonic acid and α-methylstyrenesulfonic acid; C₁₋₁₀ alkyl (meth)allylsulfosuccinic acid esters; sulfo-C₂₋₆ alkyl (meth)acrylates such as sulfopropyl (meth)acrylate; and sulfonic acid group-bearing unsaturated esters such as methyl vinyl sulfonate, 2-hydroxy-3-(meth)acryloxypropylsulfonic acid, 2-(meth)acryloylamino-2,2-dimethylethanesulfonic acid, 3-(meth)acryloyloxyethanesulfonic acid, 3-(meth)acryloyloxy-2-hydroxypropanesulfonic acid, 2-(meth)acrylamido-2-methylpropanesulfonic acid and 3-(meth)acrylamido-2-hydroxypropanesulfonic acid, and salts thereof.

Copolymers prepared by copolymerizing functional group-containing polymerizable monomers serving as the starting materials for the above respective functional group-containing polymeric compounds with another polymerizable monomer may also be used as the first and second functional group-containing polymeric compounds.

Examples of such polymerizable monomers which can be copolymerized include (i) styrenic compounds such as styrene, o-methylstyrene, m-methylstyrene, p-methylstyrene, α-methylstyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene, and 3,4-dichlorostyrene; (ii) (meth)acrylate esters such as methyl acrylate, ethyl acrylate, n-butyl acrylate, isobutyl acrylate, propyl acrylate, hexyl acrylate, 2-ethylhexyl acrylate, n-octyl acrylate, dodecyl acrylate, lauryl acrylate, stearyl acrylate, 2-chloroethyl acrylate, phenyl acrylate, methyl α-chloroacrylate, methyl methacrylate, ethyl methacrylate, n-butyl methacrylate, isobutyl methacrylate, propyl methacrylate, hexyl methacrylate, 2-ethylhexyl methacrylate, n-octyl methacrylate, dodecyl methacrylate, lauryl methacrylate and stearyl methacrylate; (iii) vinyl esters such as vinyl acetate, vinyl propionate, vinyl benzoate and vinyl butyrate; (iv) (meth)acrylic acid derivatives such as acrylonitrile and methacrylonitrile; (v) vinyl ethers such as vinyl methyl ether, vinyl ethyl ether and vinyl isobutyl ether; (vi) vinyl ketones such as vinyl methyl ketone, vinyl hexyl ketone and methyl isopropenyl ketone; (vii) N-vinyl compounds such as N-vinylpyrrole, N-vinylcarbazole, N-vinylindole and N-vinylpyrrolidone; and (viii) vinyl fluoride, vinylidene fluoride, tetrafluoroethylene and hexafluoropropylene, and fluoroalkyl group-bearing (meth)acrylate esters such as trifluoroethyl acrylate and tetrafluoropropyl acrylate. These may be used singly or as combinations of two or more thereof.

Preferred examples of the above first and second functional group-containing polymeric compounds include styrene resins, acrylic resins, methacrylic resins, polyethylene resins, polypropylene resins, silicone resins, polyester resins, polyurethane resins, polyamide resins, epoxy resins, polyvinyl butyral resins, rosins, terpene resins, phenolic resins, melamine resins, guanamine resins, oxazoline resins and carbodiimide resins. These may be used singly or as combinations of two or more thereof.

The method of grafting the first and second functional group-containing polymeric compounds from the surfaces of the core particles of the above-described (A) particles and the (B) particles is not subject to any particular limitation. Any of various known methods may be used for this purpose.

If the particles are organic particles, the surface of a prefabricated organic core particle may be covered with the functional group-containing polymeric compound to give an organic particle having the functional group-containing polymeric compound on the surface.

The organic core particle is not subject to any particular limitation, provided it is insoluble in the reaction solvent used for grafting. For example, use may be made of fine particles of any of the various above-mentioned synthetic resins or fine particles of a natural polymer. The organic core particles in this case may be treated with the above-mentioned surface treatment agent.

If the particles are inorganic particles, the surface of the inorganic particle or the surface of the inorganic particle that has been treated with a surface treatment agent may be covered with the functional group-containing polymeric compound to give an inorganic-organic composite particle which includes a functional group-containing polymeric compound.

No particular limitation is imposed on the method used to graft the functional group-bearing polymeric compound from the surface of the organic core particle and the inorganic particle. Exemplary methods include techniques involving the use of a spray dryer, seed polymerization, or adsorption of the functional group-containing polymeric compound onto the core particle, and a graft polymerization process that chemically bonds the functional group-containing polymeric compound with the core particle.

The grafting reaction conditions depend on such factors as the type of reaction, the type of starting materials used, the type of functional group to be introduced, the type of functional group-containing polymeric compound, the particle concentration and the particle specific gravity, and thus cannot be strictly specified. However, the reaction temperature is typically in a range of from 10 to 200° C., preferably from 30 to 130° C., and more preferably from 40 to 90° C. During the reaction, it is desirable to stir the system at a rate capable of uniformly dispersing the particles.

The grafting reaction is preferably carried out in the presence of a solvent. By carrying out grafting in the presence of a solvent, functional groups can be uniformly introduced onto the surface of the core particles (organic particles, inorganic particles) used as a starting material without applying excessive impact forces to the particles obtained by the reaction and thus compromising their physical properties. Hence, the (A) particles and the (B) particles can be obtained in a monodispersed state.

The reaction solvent is not subject to any particular limitation, and may be selected from among general solvents that are appropriate for the particular starting materials used in the reaction. Illustrative examples of reaction solvents that may be used include water; alcohols such as methanol, ethanol, 1-propanol, 2-propanol, 1-butanol, 2-butanol, isobutyl alcohol, tert-butyl alcohol, 1-pentanol, 2-pentanol, 3-pentanol, 2-methyl-1-butanol, isopentyl alcohol, tert-pentyl alcohol, 1-hexanol, 2-methyl-1-pentanol, 4-methyl-2-pentanol, 2-ethylbutanol, 1-heptanol, 2-heptanol, 3-heptanol, 2-octanol, 2-ethyl-1-hexanol, benzyl alcohol and cyclohexanol; ether alcohols such as methyl cellosolve, ethyl cellosolve, isopropyl cellosolve, butyl cellosolve and diethylene glycol monobutyl ether; ketones such as acetone, methyl ethyl ketone, methyl isobutyl ketone and cyclohexanone; esters such as ethyl acetate, butyl acetate, ethyl propionate and cellosolve acetate; aliphatic or aromatic hydrocarbons such as pentane, 2-methylbutane, n-hexane, cyclohexane, 2-methylpentane, 2,2-dimethylbutane, 2,3-dimethylbutane, heptane, n-octane, isooctane, 2,2,3-trimethylpentane, decane, nonane, cyclopentane, methylcyclopentane, methylcyclohexane, ethylcyclohexane, p-menthane, dicyclohexyl, benzene, toluene, xylene and ethylbenzene; halogenated hydrocarbons such as carbon tetrachloride, trichloroethylene, chlorobenzene and tetrabromoethane; ethers such as ethyl ether, dimethyl ether, trioxane and tetrahydrofuran; acetals such as methylal and diethylacetal; aliphatic acids such as formic acid, acetic acid and propionic acid; and sulfur or nitrogen-bearing organic compounds such as nitropropene, nitrobenzene, dimethylamine, monoethanolamine, pyridine, dimethylformamide and dimethylsulfoxide. Any one or combinations of two or more thereof may be used.

As noted above, various grafting methods may be used. Of these, the use of graft polymerization is preferred for the following reasons: (1) the ability to form a polymer layer which is relatively thick and does not readily dissolve out even during long-term dispersion in a solvent, (2) the ability to confer diverse functional groups and thus impart diverse surface properties by changing the type of monomer, and (3) grafting at a high density is possible by carrying out polymerization based on polymerization initiating groups introduced onto the surface of the particles.

The grafting method is exemplified here by a method in which the grafted chains are prepared beforehand by graft polymerization, then are chemically bonded to the surface of the particle; and a method in which graft polymerization is carried out at the surface of the particle. Although either method may be used, to increase the density of the grafted chains at the surface of the particle, the latter approach, which is less subject to adverse effects such as steric hindrance, is preferred.

Illustrative examples of the chemical bonds between the organic core particle and the inorganic particle include covalent bonds, hydrogen bonds, and coordinate bonds.

Examples of graft polymerization reactions include addition polymerization reactions such as free-radical polymerization, ionic polymerization, oxidative anionic polymerization and ring-opening polymerization; polycondensation reactions such as elimination polymerization, dehydrogenation polymerization, and denitrogenation polymerization; hydrogen transfer polymerization reactions such as polyaddition, isomerization polymerization, and group transfer polymerization; and addition condensation. Of these, free-radical polymerization is especially preferred because it is simple and highly cost-effective, and is commonly used for the industrial synthesis of various polymers. Where there is a need to control the molecular weight of the grafted chains, the molecular weight distribution or the grafting density, use can be made of living radical polymerization.

Living radical polymerization is broadly divided into three types, any of which may be used in the present invention: (i) a dissociation-bonding mechanism in which polymerization proceeds by activation involving the use of typically heat or light to reversibly cleave the covalent bond on a dormant species P-X so that it dissociates to a P radical and an X radical; (ii) atom transfer radical polymerization (ATRP), which proceeds by the activation of P-X under the action of a transition metal complex; and (iii) an exchange chain transfer mechanism in which polymerization proceeds by P-X triggering an exchange reaction with another radical.

The graft polymerization conditions are not subject to any particular limitation. Various known conditions may be employed according to such considerations as the monomer being used.

For example, when grafting is effected by carrying out free radical polymerization at the surface of the organic polymer particle or the inorganic particle, the quantity of monomer (monomer serving as a starting material for the first or second functional group-containing polymeric compound) which can be reacted therewith per 0.1 mole of reactive functional groups introduced onto the particle (or originally present thereon) is generally from 1 to 300 moles, and the quantity of polymerization initiator used is generally from 0.005 to 30 moles. The polymerization temperature is generally from −20 to 1,000° C., and the polymerization time is generally from 0.2 to 72 hours.

When the (A) particles and the (B) particles are prepared by graft polymerizing functional group-bearing monomers from the surface of organic core particles and the inorganic particles, depending on the intended application, use may be made of a suitable amount of crosslinking agent.

Illustrative, non-limiting, examples include aromatic divinyl compounds such as divinylbenzene and divinylnaphthalene; and compounds such as ethylene glycol diacrylate, ethylene glycol dimethacrylate, triethylene glycol dimethacrylate, tetraethylene glycol dimethacrylate, 1,3-butylene glycol dimethacrylate, trimethylolpropane triacrylate, trimethylolpropane trimethacrylate, 1,4-butanediol diacrylate, neopentyl glycol diacrylate, 1,6-hexanediol diacrylate, pentaerythritol triacrylate, pentaerythritol tetraacrylate, pentaerythritol dimethacrylate, pentaerythritol tetramethacrylate, glycerol acryloxy dimethacrylate, N,N-divinyl aniline, divinyl ether, divinyl sulfide and divinyl sulfone. These may be used singly or as combinations of two or more thereof.

Polymerization initiators that may be used in radical polymerization are not subject to any particular limitation, and may be suitably selected from among known radical polymerization initiators. Illustrative examples include benzoyl peroxide, cumene hydroperoxide, t-butyl hydroperoxide, persulfates such as sodium persulfate and ammonium persulfate, and azo compounds such as azobisisobutyronitrile, azobismethylbutyronitrile and azobisisovaleronitrile. These may be used singly or as combinations of any two or more thereof.

The polymerization solvent used may be one that is suitably selected from among the various solvents mentioned above based on such considerations as the target particles and the starting monomers to be used.

When the (A) particles and (B) particles are produced by polymerization reactions, depending on the polymerization process used, known (polymer) dispersants, stabilizers, emulsifying agents, surfactants, catalysts (reaction accelerators) and the like which are commonly employed in polymer synthesis may be included as appropriate.

The polymer layer formed by graft polymerization, aside from being formed by graft polymerization at the surface of the organic core particles or inorganic particles, may alternatively be formed, as noted above, by reacting an already prepared functional group-bearing polymeric compound with reactive functional groups on the surface of the particles. In such a case, the proportions in which the functional group-bearing polymeric compound and the core particles are compounded, while not subject to any particular limitation, are typically such that the amount of the functional group-bearing polymeric compound added, expressed as an equivalent ratio with respect to the reactive functional groups on the core particle, is in a range of about 0.3 to 30, preferably 0.8 to 20, and more preferably 1 to 10.

Although it is possible to produce (A) particles and (B) particles from the surface of which has been grafted a functional group-containing polymeric compound even when the amount of functional group-containing polymeric compound added exceeds an equivalent ratio of 30, this is often undesirable for production because of the increased amount of residual unreacted polymeric compound. On the other hand, at an equivalent ratio of less than 0.3, adhesion by the protrusions on the rough particle obtained using the resulting (A) particles (or (B) particles) may decrease.

Illustrative examples of methods that may be used to react the core particle with the functional group-containing polymeric compound include dehydration reactions, nucleophilic substitution reactions, electrophilic substitution reactions, electrophilic addition reactions, and adsorption reactions.

In the rough particles of the invention, the (B) particles have an average particle size which is not subject to any particular limitation, provided it is smaller than the average particle size of the (A) particles. Generally, however, the (B) particles have an average particle size which is preferably not more than ½, more preferably not more than ⅕, and even more preferably not more than ⅛, the average particle size of the (A) particles, with the upper limit being about 100 μm. It is desirable for the average particle size of the (B) particles to have an upper limit of not more than 100 μm, preferably not more than 20 μm, and more preferably not more than 5 μm. The lower limit in the average particle size of the (B) particles is at least 0.003 μm, preferably at least 0.08 μm, and more preferably at least 0.2 μm.

At an average particle size below 0.003 μm, surface treatment of the (B) particles may be difficult. On the other hand, at an average particle size greater than 100 μm, although protrusions can be added to the (A) particles, the surface area under load becomes too large, which may, depending on the intended application, have adverse effects such as the loss of (B) particles (protrusions).

The average particle size of the (A) particles varies with the average particle size of the (B) particles, and thus cannot be strictly specified, although an average particle size in a range of about 0.1 to about 1,000 μm is preferred. Outside of this average particle size range, the properties of rough particles may fail to appear. The average particle size of the (A) particles is more preferably from 0.3 to 200 μm, even more preferably from 0.8 to 50 μm, and most preferably from 1.0 to 2.0 μm.

In this invention, “average particle size” refers to the average value obtained by using a scanning electron microscope (S-4800 manufactured by Hitachi, Ltd.; referred to below as “SEM”) to photograph the particles (n=300) at a measurable magnification (from 300 to 20,000×), and measuring the particle diameters on the resulting two-dimensional images.

The number-average molecular weights of the polymeric compound containing the first functional group (first functional group-containing polymeric compound) and the polymeric compound containing the second functional group (second functional group-containing polymeric compound) are preferably from 500 to 500,000, and more preferably from 1,000 to 100,000. At a number-average molecular weight above 500,000, the viscosity in the solvent becomes too high, which may have an adverse effect on the monodispersed particles. On the other hand, at a number-average molecular weight below 500, addition of the protrusions is possible, but the bond strength is weak, which may result in protrusions coming off and other undesirable effects. The number-average molecular weight is a measured value obtained by gel permeation chromatography (GPC).

Although an average number of functional groups per molecule of the first and second functional group-containing polymeric compounds of two or more suffices, to further increase the bond strength of the (A) particles and the (B) particles, it is desirable that the average number of functional groups be preferably at least 3, more preferably at least 4, and even more preferably at least 5.

At a functional group equivalent weight of less than 50, depending on the type of functional group, self-crosslinking occurs, which may adversely affect the bond strength of the (B) particles. On the other hand, at a functional group equivalent weight of more than 2,000, protrusions may be added, but the bond strength weakens, which may give rise to undesirable effects such as the loss of protrusions. The functional group equivalent weight is preferably from 80 to 1,500, more preferably from 100 to 1,000, and even more preferably from 130 to 180.

“Equivalent weight” refers to a fixed quantity assigned to each compound based on the quantitative relationship among the substances in the chemical reaction. For example, in this invention, it expresses the chemical formula weight of one molecule (in the case of a polymer, the average weight) per mole of reactive functional groups.

Next, the method of producing the rough particles is described.

The method of producing the rough particles according to the invention is not subject to any particular limitation, so long as it is a method capable of uniting (A) particles from the surface of which is grafted the above-described polymeric compound containing a first functional group and (B) particles from the surface of which is grafted the above-described polymeric compound containing a second functional group capable of reacting with the first functional group to form rough particles by means of chemical bonds between the first functional groups and the second functional groups. However, use may be made of a method that involves mixing together the (A) particles and the (B) particles in the presence of at least one type of solvent which dissolves the respective polymeric compounds on the (A) and (B) particles, and causing the first functional group to react with the second functional group.

Treatment in this way enables the functional groups in the polymeric compounds to be used to the fullest possible degree. That is, the number of reaction sites increase, creating a larger bonding surface area. This not only enables the bonds between the (A) particles and the (B) particles to be made more secure, it also increases the surface area of contact between the polymeric compounds, so that adhesive forces particular to the polymeric compound also come into play, resulting in the formation of even stronger bonds.

Moreover, the dispersibility of the (A) and (B) particles in the solvent also rises, as a result of which the settling rate of the particles changes, facilitating the formation of asperities.

Based on such considerations as the materials making up the (A) particles and the (B) particles and the types of the first and second functional group-containing polymeric compounds, any reaction solvent from among those listed above may be suitably selected and used. However, from the standpoint of such considerations as the solubility of the first and second functional group-containing polymeric compounds, it is especially preferable to use a reaction solvent in 100 g of which (in the case of a solvent mixture, 100 g of the overall solvent mixture) at least 0.01 g, preferably at least 0.05 g, more preferably at least 0.1 g, even more preferably at least 1 g, and most preferably at least 2 g, of each of the polymeric compounds will dissolve.

Preferred examples of the solvent include water; alcohols such as methanol, ethanol and 2-propanol; ether alcohols such as methyl cellosolve, ethyl cellosolve, isopropyl cellosolve, butyl cellosolve and diethylene glycol monobutyl ether; and water-soluble organic solvents such as acetone, tetrahydrofuran, acetonitrile and dimethylformamide; as well as solvent mixtures thereof.

The other reaction conditions vary depending on such factors as the types of the first and second functional groups, the particle concentration and the particle specific gravities, and thus cannot be strictly specified. Even so, the reaction temperature is typically in a range of from 10 to 200° C., preferably 30 to 130° C., and more preferably 40 to 90° C. The reaction time when the reaction is carried out between 40 and 90° C. is typically about 2 to 48 hours, and preferably about 8 to 24 hours.

Rough particles can be obtained even when the reaction is carried out for a long time exceeding 48 hours, although carrying out the reaction under conditions requiring a long period of time is not advisable from the standpoint of production efficiency.

The solution concentration at the time of the bonding reaction, as calculated by the following formula, is typically from 1 to 60 wt %, preferably 5 to 40 wt %, and more preferably 10 to 30 wt %.
Solution concentration (wt %)=[(weight of (A) particles+weight of (B) particles)/total weight of solution]×100

Here, at a solution concentration above 60 wt %, the amount of (A) particles or (B) particles is too high, as a result of which the balance within the solution may collapse, making it difficult to obtain monodispersed rough particles. On the other hand, at a solution concentration below 1 wt %, rough particles can be obtained, but this is not advisable as it may make it necessary to carry out the reaction over an extended period of time or otherwise invite a decline in productivity.

During production of the rough particles, known dispersants, antioxidants, stabilizers, emulsifying agents, catalysts and the like may be suitably included within the reaction system in an amount of from 0.0001 to 50 wt % of the reaction solution.

Illustrative examples of dispersants and stabilizers that may be used include polystyrene derivatives such as polyhydroxystyrene, polystyrene sulfonic acid, vinylphenol-(meth)acrylate copolymers, styrene-(meth)acrylate copolymers and styrene-vinylphenol-(meth)acrylate copolymers; poly(meth)acrylic acid derivatives such as poly(meth)acrylic acid, poly(meth)acrylamide, polyacrylonitrile, poly(ethyl (meth)acrylate) and poly(butyl (meth)acrylate); polyvinyl alkyl ether derivatives such as polymethyl vinyl ether, polyethyl vinyl ether, polybutyl vinyl ether and polyisobutyl vinyl ether; cellulose and cellulose derivatives such as methyl cellulose, cellulose acetate, cellulose nitrate, hydroxymethyl cellulose, hydroxyethyl cellulose, hydroxypropyl cellulose and carboxymethyl cellulose; polyvinyl acetate derivatives such as polyvinyl alcohol, polyvinyl butyral, polyvinyl formal and polyvinyl acetate; nitrogen-containing polymer derivatives such as polyvinyl pyridine, polyvinyl pyrrolidone, polyethyleneimine and poly(2-methyl-2-oxazoline); polyvinyl halide derivatives such as polyvinyl chloride and polyvinylidene chloride; and polysiloxane derivatives such as polydimethylsiloxane. These may be used singly or as combinations of two or more thereof.

Illustrative examples of emulsifying agents (surfactants) include anionic emulsifying agents such as alkyl sulfates (e.g., sodium laurylsulfate), alkylbenzene sulfonates (e.g., sodium dodecylbenzene sulfonate), alkylnaphthalene sulfonates, fatty acid salts, alkyl phosphates and alkyl sulfosuccinates; cationic emulsifying agents such as alkylamine salts, quaternary ammonium salts, alkyl betaine and amine oxides; and nonionic emulsifying agents such as polyoxyethylene alkyl ethers, polyoxyethylene alkyl ethers, polyoxyethylene alkylallyl ethers, polyoxyethylene alkylphenyl ethers, sorbitan fatty acid esters, glycerol fatty acid esters and polyoxyethylene fatty acid esters. These may be used singly or as combinations of two or more thereof.

Alternatively, the rough particles can be produced by using any of various know composite particle forming techniques, such as an anion-cation adsorption, electrostatic adsorption or spraying, to form the (A) particles and the (B) particles into composite particles, then applying heat to melt the first and second functional group-containing polymeric compounds and at the same time induce a reaction.

Even in this latter method, because the first and second functional groups react when the respective polymeric compounds are in a molten state, as in the earlier described method, the number of reaction sites increases, resulting in a larger bonding surface area, enabling the bonds between the (A) particles and the (B) particles to be made stronger.

In the production of the rough particles, it is important to adjust the conditions so that, at the very least, the (A) particles are not uniformly covered by (B) particles. Rough particles in which the (A) particles have been uniformly covered lack a sufficient degree of roughness at the surface, and may thus fail to exhibit the distinctive functionality of rough particles.

By suitably adjusting such factors as the amounts in which the (A) particles and the (B) particles are added, the reaction temperature, the reaction time and the type of polymerization solvent, it is possible to vary the diameter of the protrusions formed by the (B) particles and the spacing of the protrusions. To obtain rough particles in which the (A) particle is not uniformly covered by (B) particles and which have thereon suitably spaced protrusions, although the particle sizes and specific gravities of the (A) particles and the (B) particles also exert a strong influence, assuming the particle size ratio between the (A) particles and the (B) particles is be more or less as mentioned above, mixing treatment may be carried out by setting the amount of (B) particles added with respect to the (A) particles at generally from 0.01 to 50 wt %, preferably from 0.1 to 20 wt %, and more preferably from 1 to 15 wt %.

### EXAMPLES

Synthesis Examples, Examples of the invention, and Comparative Examples are given below by way of illustration, and not by way of limitation.

In the following description, the number-average molecular weights are measured values obtained by gel filtration chromatography.

Molecular Weight Measurement Conditions

GPC apparatus: C-R7A, manufactured by Shimadzu Corporation
Detector: UV spectrophotometer detector (SPD-6A), manufactured by Shimadzu Corporation
Pump: Molecular weight distribution measurement system pump (LC-6AD), manufactured by Shimadzu Corporation
Columns: A total of three columns connected in series;

two Shodex KF804L (Showa Denko K.K.) columns and one Shodex KF806 (Showa Denko)
Solvent: Tetrahydrofuran
Measurement temperature: 40° C.
   (1) Synthesis of Core Particles

### Synthesis Example 1

The starting compounds and other ingredients shown below were mixed in the indicated proportions and the resulting mixture was added all at once to a 500 ml flask. Dissolved oxygen in the mixture was displaced with nitrogen, following which the flask contents were heated at an oil bath temperature of 80° C. for about 15 hours under stirring and a stream of nitrogen to give a carboxyl group-containing styrene-based copolymer particle solution.

The resulting particle solution was repeatedly washed and filtered three to five times with a water-methanol solvent mixture (weight ratio, 3:7) using a known suction filtration apparatus, then vacuum dried, yielding Core Particles 1. The particle diameter of these Core Particles 1 was examined and measured by scanning electron microscopy (SEM), whereupon the particles were found to be spherical particles having an average particle size of 3.5 μm.

| | | |
|---|---|---|
| Styrene | 48.2 | g |
| Methacrylic acid | 20.6 | g |
| Methanol | 218.0 | g |
| Water | 52.0 | g |
| Azobis(2-methylbutyronitrile) (ABNE) | 3.0 | g |
| Styrene-methacrylic copolymer resin solution | 70.0 | g |

(The styrene-methacrylic copolymer resin solution was a 40 wt % solution of styrene/2-hydroxyethyl methacrylate (=2:8) in methanol.

### Synthesis Example 2

Aside from using the starting compounds and other ingredients shown below in the indicated proportions, Core Particles 2 were obtained in the same way as in Synthesis Example 1. The particle diameter of these Core Particles 2 was examined and measured by SEM, whereupon the particles were found to be spherical particles having an average particle size of 12.9 μm.

| | | |
|---|---|---|
| Styrene | 48.2 | g |
| Acrylic acid | 20.6 | g |
| Methanol | 162.0 | g |
| Ethanol | 54.0 | g |
| Water | 54.0 | g |
| Azobis(2-methylbutyronitrile) (ABNE) | 3.1 | g |
| Styrene-methacrylic copolymer resin solution | 60.0 | g |

(The styrene-methacrylic copolymer resin solution was a 40 wt % solution of styrene/2-hydroxyethyl methacrylate (=2:8) in methanol.

### Synthesis Example 3

Aside from using the starting compounds and other ingredients shown below in the indicated proportions and setting the oil bath temperature to 700C, Core Particles 3 were obtained in the same way as in Synthesis Example 1. The particle diameter of these Core Particles 3 was examined and measured by SEM, whereupon the particles were found to be spherical particles having an average particle size of 0.4 μm.

| | | |
|---|---|---|
| Styrene | 23.9 | g |
| Methacrylic acid | 6.0 | g |
| Methanol | 231.7 | g |
| Water | 67.3 | g |
| Azobis(2-methylbutyronitrile) (ABNE) | 1.2 | g |
| Styrene-methacrylic copolymer resin solution | 86.3 | g |

(The styrene-methacrylic copolymer resin solution was a 40 wt % solution of styrene/2-hydroxyethyl methacrylate (=2:8) in methanol.

### Synthesis Example 4

Aside from using the starting compounds and other ingredients shown below in the indicated proportions and setting the oil bath temperature to 78° C., Core Particles 4 composed of a styrene homopolymer were obtained in the same way as in Synthesis Example 1. The particle diameter of these Core Particles 4 was examined and measured by SEM, whereupon the particles were found to be spherical particles having an average particle size of 4.4 μm.

| | | |
|---|---|---|
| Styrene | 73.1 | g |
| Methanol | 179.9 | g |
| Ethanol | 39.3 | g |
| Azobisisobutyronitrile (AIBN) | 3.4 | g |
| Styrene-methacrylic copolymer resin solution | 63.8 | g |

(the styrene-methacrylic copolymer resin solution was a 40 wt % solution of styrene/2-hydroxyethyl methacrylate (=2:8) in methanol.
(2) Synthesis of Functional Group-Bearing (Polymeric) Organic Compounds

### Synthesis Example 5

After initially reacting 800 g of 2,6-tolylene diisocyanate (TDI) with 441.4 g of polyoxyethylene monomethyl ether having a degree of polymerization m=8 at 50° C. for 1 hour, 8 g of carbodiimidation catalyst (3-methyl-1-phenyl-2-phospholene-1-oxide) was added and the reaction was carried out at 85° C. for 6 hours under a stream of nitrogen, yielding an end-capped carbodiimide resin (average degree of polymerization=7; average molecular weight, 1852). To this was gradually added 709.6 g of distilled water, giving a carbodiimide resin solution (resin concentration, 60 wt %). The carbodiimide equivalent weight was 265/NCN.

### Synthesis Example 6

After initially reacting 800 g of m-tetramethylxylylene dilsocyanate (TMXDI) with 16 g of carbodiimidation catalyst at 180° C. for 26 hours, an isocyanate-terminated m-tetramethylxylylene carbodiimide resin was obtained. Next, 668.9 g of the resulting carbodiimide and 333.9 g of polyoxyethylene monomethyl ether having a degree of polymerization m=12 were reacted at 140° C. for 6 hours. To this was gradually added 668.5 g of distilled water, yielding a carbodiimide resin solution (resin concentration, 60 wt %). The carbodilmide equivalent weight was 336/NCN (average degree of polymerization=10; number-average molecular weight, 3364).

(3) Synthesis of (A) and (B) Particles

### Synthesis Example 7

The starting compounds and other ingredients shown below were mixed in the indicated proportions and the resulting mixture was added all at once to a 1000 ml flask. The mixture was then heated and stirred under a stream of nitrogen and at an oil bath temperature of 45° C. for about 15 hours, thereby forming a carbodiimide-containing composite particle solution.

The resulting particle solution was repeatedly washed and filtered three to five times with a water-methanol solvent mixture (weight ratio, 3:7) using a known suction filtration apparatus, then vacuum dried, yielding composite particles (Grafted Particles 1). These Grafted Particles 1 were measured using a Fourier transform infrared spectrophotometer (FT-IR8200PC, manufactured by Shimadzu Corporation; abbreviated below as “FT-IR”), whereupon an absorption peak due to carbodiimide groups was observed at a wavelength of about 2150 cm⁻¹, confirming that a carbodiimide group-containing polymer had been grafted.

| | |
|---|---|
| Core Particle 1 | 25.0 g |
| Solution obtained in Synthesis Example 5 | 115.4 g |
| Water | 136.7 g |
| Methanol | 506.4 g |

### Synthesis Example 8

Aside from using the Core Particles 2 and the solution obtained in Synthesis Example 6, particles having grafted carbodiimide groups (Grafted Particles 2) were obtained by the same method as in Synthesis Example 7.

These Grafted Particles 2 were measured by FT-IR, whereupon an absorption peak due to carbodiimide groups was observed at a wavelength of about 2150 cm⁻¹ confirming that a carbodiimide group-containing polymer had been grafted.

### Synthesis Example 9

Aside from using the Core Particles 3, particles having grafted carbodiimide groups (Grafted Particles 3) were obtained by the same method as in Synthesis Example 7.

These Grafted Particles 3 were measured by FT-IR, whereupon an absorption peak due to carbodiimide groups was observed at a wavelength of about 2150 cm⁻¹, confirming that a carbodiimide group-containing polymer had been grafted.

### Synthesis Example 10

The starting compounds and other ingredients shown below were mixed in the indicated proportions and the resulting mixture was added all at once to a 300 ml flask. The mixture was then dispersed with a stirrer at room temperature for one hour. Next, 0.1 g of the catalyst tributylamine was added, and heating was carried out under a stream of nitrogen and at an oil bath temperature of 70° C. for about 15 hours, thereby forming an epoxy-containing particle solution.

The resulting particle solution was repeatedly washed and filtered three to five times with a water-methanol solvent mixture (weight ratio, 3:7) using a known suction filtration apparatus, then vacuum dried, yielding composite particles (Grafted Particles 4). These Grafted Particles 4 were measured by FT-IR, whereupon an absorption peak due to epoxy groups was observed at a wavelength of about 910 cm⁻¹, confirming that an epoxy group-containing polymer had been grafted.

| | |
|---|---|
| Core Particle 1 | 12.0 g |
| Denacol EX-1610 | 11.9 g |
| Methanol | 33.2 g |
| Water | 62.3 g |

(The Denacol EX-1610 was an epoxy compound produced by Nagase ChemteX Corporation and having an epoxy equivalent weight of 170.)

### Synthesis Example 11

Twenty grams of spherical silica particles having an average particle size of 0.2 μm (produced by Ube Nitto Kasei, Ltd.) were thoroughly dispersed in 80 g of dimethylformamide (DMF) within a 200 ml flask. Next, 0.4 g of 3-methacryloxypropyltrimethoxysilane (a silane coupling agent produced by Chisso Corporation) was added and stirring was carried out for 30 minutes at 70° C. The organic compounds AIBN (0.32 g), styrene (8.4 g) and methacrylic acid (3.6 g) were then added, after which heating was carried out at 70° C. for about 15 hours to effect the reaction.

Following reaction completion, the system was repeatedly washed with tetrahydrofuran (THF) and filtered about four times to remove unreacted monomer and ungrafted polymer, then dried, yielding particles (Grafted Particles 5). An IR spectrum of the Grafted Particles 5 was measured by FT-IR, whereupon absorption attributable to benzene rings was observed near 700 cm⁻¹ and absorption attributable to ester groups was observed near 1720 cm⁻¹. These results confirmed that a carboxyl group-bearing polymer (styrene-methacrylic acid copolymer) had grafted onto the particles. The number-average molecular weight was about 11,000, and the average carboxyl group equivalent weight (theoretical) was 287.

### Synthesis Example 12

Ten grams of alumina particles having an average particle size of 0.4 μm obtained by classifying alumina particles (produced by Admatechs Co., Ltd.) was thoroughly dispersed in 90 g of DMF within a 200 ml flask. Next, 0.2 g of 3-methacryloxypropyltrimethoxysilane was added and the system was stirred at 70° C. for 30 minutes. This was followed by the addition of 0.32 g of AIBN, 7.0 g of styrene and 3.0 g of methacrylic acid, after which heating was carried out at 70° C. for about 15 hours to effect the reaction.

Following reaction completion, particles (Grafted Particles 6) were obtained by carrying out the same procedure as in Synthesis Example 11. An IR spectrum of the Grafted Particles 6 was measured by FT-IR, whereupon absorption attributable to benzene rings was observed near 700 cm⁻¹ and absorption attributable to ester groups was observed near 1720 cm⁻¹. These results confirmed that a carboxyl group-bearing polymer (styrene-methacrylic acid copolymer) had grafted onto the particles. The number-average molecular weight was about 35,000, and the average carboxyl group equivalent weight (theoretical) was 287.

### Synthesis Example 13

Aside from using spherical silica particles having an average particle size of 9.9 μm (Ube Nitto Kasei, Ltd.), composite particles (Grafted Particles 7) were obtained by a method similar to that in Synthesis Example 12. An IR spectrum of the Grafted Particles 7 was measured by FT-IR, whereupon absorption attributable to benzene rings was observed near 700 cm⁻¹ and absorption attributable to ester groups was observed near 1720 cm⁻¹. These results confirmed that a carboxyl group-bearing polymer (styrene-methacrylic acid copolymer) had grafted onto the particles. The number-average molecular weight was about 35,000, and the average carboxyl group equivalent weight (theoretical) was 287.

### Synthesis Example 14

Aside from changing the ratio of styrene and methacrylic acid, composite particles (Grafted Particles 8) were obtained by the same method as in Synthesis Example 11. An IR spectrum of the Grafted Particles 8 was measured by FT-IR, whereupon absorption attributable to benzene rings was observed near 700 cm⁻¹ and absorption attributable to ester groups was observed near 1720 cm⁻¹. These results confirmed that a carboxyl group-bearing polymer (styrene-methacrylic acid copolymer) had grafted onto the particles. The number-average molecular weight was about 35,000, and the average carboxyl group equivalent weight (theoretical) was 1720.

(3) Production of Rough particles

### Example 1

The starting compounds and other ingredients shown below were added all at once in the indicated proportions to a 100 ml flask and ultrasonically dispersed, then heated and stirred under a stream of nitrogen and at an oil bath temperature of 45° C. for about 15 hours, thereby producing a rough particle solution.

The resulting particle solution was repeatedly washed and filtered three to five times with methanol using a known suction filtration apparatus to remove insolubles, then vacuum dried, yielding rough particles for plating or vapor deposition treatment (referred to below as “rough particles”). The shape of these particles was examined by SEM, whereupon they were found to be particle clusters having asperities formed by the bonding, at least at the surface, of three or more non-agglomerated, monodispersed primary particles. FIG. 1 shows a scanning electron micrograph of one of the rough particles thus obtained.

When 10 g of the carbodiimide resin used in the production of Grafted Particles 1 and 3 g of the styrene-methacrylic acid copolymer used in the production of Grafted Particles 5 were placed in 100 g of the solvent ingredients used, both dissolved.

| | | |
|---|---|---|
| Particle (A): Grafted Particle 1 | 5.0 | g |
| Particle (B): Grafted Particle 5 | 0.5 | g |
| THF | 31.5 | g |
| Methanol | 9.75 | g |
| Water | 5.25 | g |

### Example 2

Aside from changing the (A) particles to Grafted Particles 2 and changing the (B) particles to Grafted Particles 6, rough particles were obtained by the same method as in Example 1.

The shapes of these particles were examined by SEM, whereupon they were found to be particle clusters having asperities formed by the bonding, at least at the surface, of three or more non-agglomerated, monodispersed primary particles.

When 10 g of the carbodiimide resin used in the production of Grafted Particles 2 and 2 g of the styrene-methacrylic acid copolymer used in the production of Grafted Particles 5 were placed in 100 g of the solvent ingredients used, both dissolved.

### Example 3

The starting compounds and other ingredients shown below were added all at once in the indicated proportions to a 100 ml flask and ultrasonically dispersed, following which 0.05 g of tributylamine was added as the catalyst and heating was carried out under a stream of nitrogen and at an oil bath temperature of 55° C. for about 15 hours, thereby producing a rough particle solution.

The resulting particle solution was repeatedly washed and filtered three to five times with methanol using a known suction filtration apparatus to remove insolubles, then vacuum dried, yielding composite particles. The shape of these particles was examined by SEM, whereupon they were found to be particle clusters having asperities formed by the bonding, at least at the surface, of three or more non-agglomerated, monodispersed primary particles.

When 10 g of the epoxy compound used in the production of Grafted Particles 4 and 3 g of the styrene-methacrylic acid copolymer used in the production of Grafted Particles 5 were placed in 100 g of the solvent ingredients used, both dissolved.

| | | |
|---|---|---|
| Particle (A): Grafted Particle 4 | 5.0 | g |
| Particle (B): Grafted Particle 5 | 0.5 | g |
| THF | 31.5 | g |
| Methanol | 9.75 | g |
| Water | 5.25 | g |

### Example 4

Aside from changing the (A) particles to Grafted Particles 7 and changing the (B) particles to Grafted Particles 3, rough particles obtained by the same method as in Example 1. The shapes of these particles were examined by SEM, whereupon they were found to be particle clusters having asperities formed by the bonding, at least at the surface, of three or more non-agglomerated, monodispersed primary particles.

When 10 g of the carbodiimide resin used in the production of Grafted Particles 7 and 3 g of the styrene-methacrylic acid copolymer used in Grafted Particles 5 were placed in 100 g of the solvent ingredients used, both dissolved.

### Example 5

Aside from changing the (B) particles to Grafted Particles 8, rough particles were obtained by the same method as in Example 1. The shapes of these particles were examined by SEM, whereupon they were found to be particle clusters having asperities formed by the bonding, at least at the surface, of three or more non-agglomerated, monodispersed primary particles.

When 10 g of the carbodiimide resin used in the production of Grafted Particles 1 and 2 g of the styrene-methacrylic acid copolymer used in Grafted Particles 5 were placed in 100 g of the solvent ingredients used, both dissolved.

### Example 6

Aside from changing the solvent used to one composed of methanol alone, rough particles were obtained by the same method as in Example 1. The shapes of these particles were examined by SEM, whereupon they were found to be particle clusters having asperities formed by the bonding, at least at the surface, of three or more non-agglomerated, monodispersed primary particles.

When 2 g of the carbodiimide resin used in the production of Grafted Particles 1 and 3 g of the styrene-methacrylic acid copolymer used in Grafted Particles 5 were placed in 100 g of the solvent ingredients used, a small amount of the styrene-methacrylic acid copolymer dissolved. However, only a trace amount of the carbodiimide resin dissolved, with most turning white and settling out.

### Comparative Example 1

The starting materials shown below were added all at once in the indicated proportions to a 100 ml flask and ultrasonically dispersed, following which heating was carried out under a stream of nitrogen and at an oil bath temperature of 50° C. for about 15 hours, thereby producing a rough particle solution.

The resulting particle solution was repeatedly washed and filtered three to five times with methanol using a known suction filtration apparatus to remove insolubles, then vacuum dried, yielding composite particles. The shape of these particles was examined by SEM, whereupon almost no particles having asperities at the surface were found to be present.

| | |
|---|---|
| Core Particle 4 (polystyrene alone) | 5.0 g |
| Grafted Particle 5 | 0.5 g |
| Methanol | 49.5 g |

### Comparative Example 2

The starting materials shown below were added all at once in the indicated proportions to a 100 ml flask and ultrasonically dispersed, following which heating was carried out under a stream of nitrogen and at an oil bath temperature of 45° C. for about 15 hours, thereby producing a rough particle solution.

The resulting particle solution was repeatedly washed and filtered three to five times with methanol using a known suction filtration apparatus to remove insolubles, then vacuum dried, yielding composite particles. The shape of these particles was examined by SEM, whereupon some particles having asperities at the surface were found to be present.

| | | |
|---|---|---|
| Grafted Particle 1 | 5.0 | 9 |
| Spherical silica particles | 0.5 | g |
| (particles used in Synthesis Example 11) | | |
| THF | 31.5 | g |
| Methanol | 9.75 | g |
| Water | 5.25 | g |

### Comparative Example 3

Aside from using Core Particle 3 as the (B) particles, rough particles were obtained in the same way as in Example 2. The shape of these particles was examined by SEM, whereupon some particles having asperities at the surface were found to be present.

### Comparative Example 4

The starting materials shown below were added all at once in the indicated proportions to a 100 ml flask and ultrasonically dispersed, following which heating was carried out under a stream of nitrogen and at an oil bath temperature of 45° C. for about 15 hours, thereby producing a rough particle solution.

The resulting particle solution was repeatedly washed and filtered three to five times with methanol using a known suction filtration apparatus to remove insolubles, then vacuum dried, yielding composite particles. The shape of these particles was examined by SEM, whereupon some particles having asperities at the surface were found to be present.

| | | |
|---|---|---|
| Core Particle 2 | 5.0 | g |
| Grafted Particle 3 | 0.5 | g |
| Methanol | 33.0 | g |
| Water | 13.5 | g |

### Comparative Example 5

The starting materials shown below were added all at once in the indicated proportions to a 100 ml flask, 0.03 g of a cationic surfactant (Cation ABT₂; produced by NOF Corporation) was added, and the flask contents were ultrasonically dispersed. Next, 1.5 g of the spherical silica particles used in Comparative Example 2 were added, following which the contents were stirred with a stirrer for about 15 hours, thereby producing a rough particle solution using polar adsorption.

As in Comparative Example 1, the resulting particle solution was repeatedly washed and filtered to remove insolubles, then vacuum dried, yielding composite particles. The shape of these particles was examined by SEM, whereupon rough particles were obtained in which three or more non-agglomerated, monodispersed primary particles had bonded at the surface, albeit in a somewhat unbalanced manner.

| | |
|---|---|
| Core Particle 4 | 15.0 g |
| Methanol | 60.0 g |

Above Examples 1 to 5 and Comparative Examples 1 to 5 are summarized in Table 1 below.

TABLE 1

| | | Compound grafted | | | Compound grafted | | | |
|---|---|---|---|---|---|---|---|---|
| | | at surface of particle (A) | | | at surface of particle (B) | | | |
| | | | | Number- | | | Number- | Formation |
| | | Functional | Equivalent | average | Functional | Equivalent | average | of |
| | | group | weight | mol. wt. | group | weight | mol. wt. | asperities |
| Example | 1 | carbodiimide | 265 | 1,852 | carboxyl | 287 | 11,000 | Very good |
| | 2 | carbodiimide | 336 | 3,364 | carboxyl | 287 | 11,000 | Very good |
| | 3 | epoxy | 170 | >500 | carboxyl | 287 | 35,000 | Very good |
| | 4 | carboxyl | 287 | 35,000 | carbodiimide | 265 | 1,852 | Very good |
| | 5 | carbodiimide | 265 | 1,852 | carboxyl | 1,720 | 35,000 | Very good |
| | 6 | carbodiimide | 265 | 1,852 | carboxyl | 287 | 11,000 | Good |

| | | | | | | |
|---|---|---|---|---|---|---|
| Comparative | 1 | no surface functional groups | carboxyl | 287 | 11,000 | Very poor |
| Example | | (polystyrene) | | | | |

| | | | | | |
|---|---|---|---|---|---|
| 2 | carbodiimide | 265 | 1,852 | silica particles (no grafting) | Poor |
| 3 | carbodiimide | 336 | 3,364 | carboxyl (surface only) | Poor |

| | | | | | |
|---|---|---|---|---|---|
| 4 | carboxyl (surface only) | carbodiimide | 265 | 1,852 | Poor |

| | | | |
|---|---|---|---|
| 5 | surface cationic treatment | silica particles | Good |

Very Good: Adhesion and shape both good
Good: Adhesion good
Poor: Some adhesion
Very Poor: Substantially no adhesion

The degree of bonding by the protruding particles in the rough particles obtained in above Examples 1 to 5 and Comparative Examples 2 to 5 were evaluated as described below. The results are shown in Table 2.

Evaluating the Degree of Bonding by Protruding Particles

One gram of the rough particles obtained in the respective examples was placed in 100 ml of a water-methanol solvent mixture (weight ratio, 3:7), subjected to vibration or impact for 5 minutes with a homogenizer (US-150T; manufactured by Nissei Corporation), then transferred to a 300 ml flask. Within this flask, another 100 ml of a water-methanol solvent mixture (weight ratio, 3:7) was added and stirring was carried out at 400 rpm for 3 hours using a crescent-shaped stirring blade having a length of 8 cm, thereby imparting a shearing action to the particles. The flask contents were then filtered twice using a known suction filtration apparatus, and vacuum dried to give the particles. The shape of the particles was examined by SEM, and the degree of bonding by the protruding particles was evaluated.

TABLE 2

| | Particle shape | Particle shape | Results of |
|---|---|---|---|
| | (before test) | (after test) | evaluation |
| Example 1 | rough | rough | Very good |
| Example 2 | rough | rough | Very good |
| Example 3 | rough | rough | Good |
| Example 4 | rough | rough | Very good |
| Example 5 | rough | rough | Good |
| Example 6 | rough | rough | Good |
| Comparative Example 2 | partly rough | substantially | Very poor |
| | | no protrusions | |
| Comparative Example 3 | partly rough | substantially | Very poor |
| | | no protrusions | |
| Comparative Example 4 | partly rough | substantially | Very poor |
| | | no protrusions | |
| Comparative Example 5 | rough | partly rough | Poor |

Very Good: Had same degree of protrusions as before test
Good: Small decrease in number of adhering particles
Poor: Large decrease in number of adhering particles
Very Poor: Substantially no adhering particles

As shown in Table 2, in the rough particles obtained 10 in Examples 1 to 5 according to the invention, because the (A) particles and the (B) particles each had functional group-containing polymeric compounds grafted from their respective surfaces and were bonded by chemical bonds via the functional groups on both polymeric compounds, the protrusions thereon had excellent bond strengths. By contrast, in the rough particles obtained in Comparative Examples 2 to 5, the bond strengths of the protrusions were clearly inferior.

1. A rough particle characterized by comprising (A) a particle from a surface of which is grafted a polymeric compound containing a first functional group and (B) a particle from a surface of which is grafted a polymeric compound containing a second functional group capable of reacting with the first functional group, wherein the (A) particle and the (B) particle are united by chemical bonds between the first and second functional groups.

2. The rough particle of claim 1, characterized in that the chemical bonds are formed in a solvent that dissolves the polymeric compound containing the first functional group and the polymeric compound containing the second functional group.

3. The rough particle of claim 1, characterized in that the (A) particle is a spherical or substantially spherical particle.

4. The rough particle of claim 1, characterized in that the (A) particle or the (B) particle or both is an organic polymer particle.

5. The rough particle of claim 1, characterized in that the first functional group and the second functional group are each of at least one type selected from among active hydrogen groups, carbodiimide groups, oxazoline groups and epoxy groups.

6. The rough particle of claim 5, characterized in that the first functional group or the second functional group or both is a carbodiimide group.

7. The rough particle of claim 1, characterized in that the combination of the first functional group with the second functional group is a combination of at least one group selected from among hydroxyl groups, carboxyl groups, amino groups and mercapto groups with a carbodiimide group.

8. The rough particle of claim 1, characterized in that the (A) particle has an average particle size of from 0.1 to 1,000 μm.

9. A method of producing rough particles, characterized by mixing together (A) a particle from a surface of which is grafted a polymeric compound containing a first functional group and (B) a particle from a surface of which is grafted a polymeric compound containing a second functional group capable of reacting with the first functional group, in the presence of at least one type of solvent that dissolves the respective polymeric compounds on the surfaces of the (A) and (B) particles, and causing the first functional group to react with the second functional group.

10. The method of producing rough particles of claim 9, characterized in that at least 0.01 g of the respective polymeric compounds dissolves in 100 g of the solvent.
